(19) United States
(12) Patent Application Publication
(10) Pub. No.: US 2017/0345045 A1
(43) Pub. Date: Nov. 30, 2017

(54) TERMINAL, SERVER, POS TERMINAL FOR PROVIDING BENEFIT ABOUT PRODUCTS USING ADMISSION NUMBER OF CREDIT CARD, PAYMENT SYSTEM COMPRISING THE SAME, CONTROL METHOD THEREOF, AND NON-TRANSITORY COMPUTER READABLE STORAGE MEDIUM HAVING COMPUTER PROGRAM RECORDED THEREON

(71) Applicant: SK Planet Co., Ltd., Gyeonggi-do (KR)

(72) Inventors: Jonguk WOO, Gyeonggi-do (KR); Hokeun JEON, Seoul (KR); Jungmin PARK, Seoul (KR)

(73) Assignee: SK Planet Co., Ltd., Gyeonggi-do (KR)

(21) Appl. No.: 15/384,091

(22) Filed: Dec. 19, 2016

(30) Foreign Application Priority Data
May 27, 2016 (KR) 10-2016-0065649

(51) Int. Cl. G06Q 30/02; G06Q 20/40; G06Q 20/34; G06Q 30/06; G06Q 20/20

(52) U.S. Cl. CPC G06Q 30/0238; G06Q 30/0635; G06Q 20/202; G06Q 20/34; G06Q 20/409

(57) ABSTRACT

Provided are a terminal, a server, a POS terminal for providing a benefit about a product using an admission number of a credit card, a payment system including the same, a control method thereof, and a non-transitory computer readable storage medium having a computer program recorded thereon. The present invention has advantages of providing a benefit about a product to a client who uses a credit card, by using the admission number of the credit card so that a manufacturer may perform a promotion about the product in accordance with recognition of the product purchased by the client and the client may receive a benefit about the product without performing additional action at the time of making a payment, and the credit card company may conveniently provide a benefit to the client to increase the usage rate of the card.

### CROSS-REFERENCE TO RELATED APPLICATION

This application claims the benefit of Korean Application No. 10-2016-0065649 filed on May 27, 2016 with the Korean Intellectual Property Office, the disclosure of which is incorporated herein by reference.

### BACKGROUND OF THE INVENTION

### 1. Field of the Invention

The present invention relates to a terminal, a server, a POS terminal for providing a benefit about a product using an admission number of a credit card, a payment system comprising the same, a control method thereof and a non-transitory computer readable storage medium having a computer program recorded thereon, and more particularly, to a server, a POS terminal for providing a benefit about products using an admission number of a credit card, a payment system comprising the same, a control method thereof and a non-transitory computer readable storage medium having computer program recorded thereon which, in a state when a user of a terminal who agrees to provide personal information registers a product to purchase among promotion products in advance in a service server, when the user makes a payment with a credit card to purchase one or more products in a store using a terminal, transmits a credit card admission number, store information, and details of a purchased product from a POS terminal in the store, to a service server, transmits a credit card number and the credit card admission number to a credit card company server, transmits a client CI corresponding to the credit card number and the credit card admission number from the credit card company server to the service server, checks whether the credit card admission number transmitted from the POS terminal matches the credit card admission number transmitted from the credit card company server in the service server, checks whether a product to be purchased among the promotion products stored in advance in the service server matches the purchased product in the details of the purchased product transmitted from the POS terminal to automatically provide a benefit on the promotion product to the terminal.

### 2. Description of the Related Art

When a payment is performed using any one credit card among a plurality of credit cards, the payment is performed using a credit card available in a store among the plurality of credit cards.

In this case, when the credit card is used to make a payment, a benefit such as discount or point accumulation is provided depending on a payment amount, an alliance franchise, or the like. However, when the benefit is applied, since a product which is purchased by a client is not recognized, it is difficult to provide promotion for a specific product.

### RELATED ART DOCUMENT

### Patent Document

Patent Document 1: Korean Unexamined Patent Application Publication No. 10-2014-0124914 [Method and system for offering instant discount of payment]

### SUMMARY OF THE INVENTION

An object of the present invention is to provide a terminal, a server, a POS terminal for providing a benefit about a product using an admission number of a credit card, a payment system comprising the same, a control method thereof and a non-transitory computer readable storage medium having a computer program recorded thereon which provides a benefit on the product to a client who uses a credit card using an admission number of the credit card.

Another object of the present invention is to provide a terminal, a server, a POS terminal for providing a benefit about products using an admission number of a credit card, a payment system comprising the same, a control method thereof and a non-transitory computer readable storage medium having computer program recorded thereon, and more particularly, to a server, a POS terminal for providing a benefit about products using an admission number of a credit card, a payment system comprising the same, a control method thereof and a non-transitory computer readable storage medium having computer program recorded thereon which, in a state when a user of a terminal who agrees to provide personal information registers a product to purchase among promotion products in advance in a service server, when the user makes a payment with a credit card to purchase one or more products in a store using a terminal, transmits a credit card admission number, store information, and details of a purchased product from a POS terminal in the store, to a service server, transmits a credit card number and the credit card admission number to a credit card company server, transmits a client CI corresponding to the credit card number and the credit card admission number from the credit card company server to the service server, checks whether the credit card admission number transmitted from the POS terminal matches the credit card admission number transmitted from the credit card company server in the service server, checks whether a product to be purchased among the promotion products stored in advance in the service server matches the purchased product in the details of the purchased product transmitted from the POS terminal to automatically provide a benefit of the promotion product to the terminal.

According to an aspect of the present invention, a control method of a service server includes receiving a wish list including product information relating to at least one product and identification information of a terminal which are transmitted from a point of contact (POC) server, by means of a communication unit; receiving an admission number, store information, and details of one or more purchased products which are transmitted from the POS terminal after a payment is made on the one or more purchased products purchased by a user of a terminal, by means of the communication unit; receiving personal information related to the terminal and admission number which are transmitted from a credit card company server, by means of the communication unit; determining whether the admission number which is transmitted from the credit card company server and the received admission number which is transmitted from the POS terminal match, by means of a control unit; checking whether there is product information included in the received details of the one or more purchased products which matches with the product information included in the wish list, by means of the control unit, when the admission number which is transmitted from the credit card company server and the received admission number which is transmitted from the POS terminal match as the determination result; and providing a benefit which is registered in advance with respect to one or more first product information to the terminal, by means of the control unit, when there is the product information included in the received details of the one or more purchased products which matches with the one or more first product information included in the wish list as the checking result.

In an embodiment of the present invention, the details of the purchased product may include at least one of one or more product names, a unique product code, a unit price, an amount, a discounted price, whether to apply a coupon, a price, payment date and time information, a total price, and a payment card type.

In an embodiment of the present invention, the providing of a benefit which is registered in advance with respect to one or more first product information to the terminal may include: storing benefit information on each of a plurality of products which is transmitted from each of a plurality of alliances in a storage unit, by means of the control unit; checking benefit information corresponding to first product information among benefit information for each of the plurality of products which is stored in the storage unit, by means of the control unit, when the admission number which is transmitted from the credit card company server and the received admission number which is transmitted from the POS terminal match and there is the product information included in the received details of the one or more purchased products which matches with the one or more first product information included in the wish list; and providing the checked benefit information to the terminal, by means of the control unit.

In an embodiment of the present invention, the benefit may be at least one of point accumulation and discount.

According to another aspect of the present invention, a control method of a payment system for providing a benefit about a product using an admission number of a credit card includes: transmitting information on agreement to provide personal information and identification information of a terminal to a credit card company server via a POC server and a service server, by means of the terminal; storing the information on agreement to provide personal information for every terminal by matching the information on agreement to provide personal information and the identification information of the terminal, by means of the credit card company server; transmitting a promotion product list to the terminal, by means of the POC server; transmitting the wish list including product information relating to at least one product selected by a user of the terminal from the promotion product list and the identification information of the terminal to the service server via the POC server, by means of the terminal; scanning one or more products to be paid selected by the user of the terminal, by means of the POS terminal; transmitting information on the scanned one or more products to be paid, a payment card type, a payment card number, identification information of the terminal, and identification information of the POS terminal to the credit card company server, by means of the POS terminal; performing an authentication procedure based on the information on one or more products to be paid, the payment card type, and the payment card number, by means of the credit card company server; and transmitting an admission number to the POS terminal when the authentication procedure is normally performed, by means of the credit card company server.

In an embodiment of the present invention, the control method may further include receiving an admission number transmitted from the credit card company server in response to the transmitted information on one or more products to be paid and transmitting the received admission number, store information, and details of purchased product to the service server, by means of the POS terminal; storing the admission number, the store information, and the details of the purchased product which are transmitted from the POS terminal, by means of the service server; transmitting personal information corresponding to the credit card number and the admission number among information on agreement to provide personal information for each of a plurality of credit card numbers which is stored in advance in the credit card company server after performing the authentication procedure to the service server, by means of the credit card company server; determining whether the admission number which is transmitted from the credit card company server and the received admission number which is transmitted from the POS terminal match, by means of the service server; checking whether there is product information included in the received details of the one or more purchased products which matches with the product information included in the wish list, by means of the service server, when the admission number which is transmitted from the credit card company server and the received admission number which is transmitted from the POS terminal match; and providing a benefit which is registered in advance with respect to one or more first product information to the terminal, by means of the service server, when there is the product information included in the received details of the one or more purchased products which matches with the one or more first product information included in the wish list.

According to still another aspect of the present invention, a computer program which executes the method according to the above-described embodiment may be stored in a non-transitory computer readable storage medium having a computer program recorded thereon configured to perform the method according to the embodiment of the present invention.

According to yet another aspect of the present invention, a service server includes: a communication unit which receives a wish list including product information relating to at least one product transmitted from a POC server and identification information of a terminal, an admission number, store information, and details of purchased product which are transmitted from a POS terminal in a state when payment is normally performed on a payment for one or more products selected by a user of the terminal, and personal information related to the terminal and the admission number transmitted from a credit card company server; a storage unit which stores the received wish list including product information relating to at least one product and admission number of the terminal; and a control unit which determines whether the admission number transmitted from the credit card company server and the received admission number transmitted from the POS terminal match, checks whether there is product information included in the received details of the one or more purchased products which matches with the one or more first product information included in the wish list when the admission number transmitted from the credit card company server and the received admission number transmitted from the POS terminal match, and provides a benefit which is registered in advance with respect to one or more first product information to the terminal when there is the product information included in the received details of the one or more purchased products which matches with the one or more first product information included in the wish list.

According to the present invention, a benefit about a product is provided to a client who uses a credit card, by using the admission number of the credit card so that a manufacturer may perform a promotion about the product in accordance with recognition of the product purchased by the client and the client may receive a benefit about the product without performing additional action at the time of making a payment, and the credit card company may conveniently provide a benefit to the client to increase the usage rate of the card.

### BRIEF DESCRIPTION OF THE DRAWINGS

FIG. 1 is a block diagram illustrating a configuration of a payment system for providing a benefit about a product using a credit card admission number according to an embodiment of the present invention.

FIGS. 2 to 4 are flowcharts illustrating a control method of a payment system for providing a benefit about a product using a credit card admission number according to an embodiment of the present invention.

FIGS. 5 and 6 are views illustrating a screen of a terminal according to an embodiment of the present invention.

### DETAILED DESCRIPTION OF THE PREFERRED EMBODIMENTS

It is noted that technical terms used in the present invention are used to just describe a specific embodiment and do not intend to limit the present invention. Further, if the technical terms used in the present invention are not particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

In addition, singular expressions used in the present invention include plurals expressions unless they have definitely opposite meanings. In the present invention, it should not analyzed that a term such as “comprising” or “including” particularly includes various components or various steps disclosed in the specification and some component or some steps among them may not be included or additional components or steps may be further included.

In addition, terms including ordinal numbers, such as ‘first’ and ‘second’, used in the present invention can be used to describe various components, but the components should not be limited by the terms. The above terms are used only to discriminate one component from the other components. For example, a first component may be named a second component and similarly, the second component may also be named the first component, without departing from the scope of the present invention.

Hereinafter, preferable exemplary embodiment of the present invention will be described in more detail with reference to the accompanying drawings. Like reference numerals refer to like elements for easy overall understanding and a duplicated description of like elements will be omitted.

Further, in the following description, a detailed explanation of known related technologies may be omitted to avoid unnecessarily obscuring the subject matter of the present invention. Further, it is noted that the accompanying drawings are only for easily understanding the spirit of the present invention and it should not be interpreted that the spirit of the present invention is limited by the accompanying drawings.

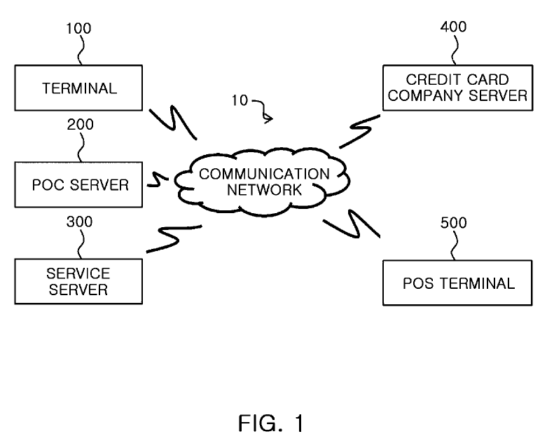

FIG. 1 is a block diagram illustrating a configuration of a payment system 10 for providing a benefit about a product using a credit card admission number according to an embodiment of the present invention.

As illustrated in FIG. 1, a payment system 10 for providing a benefit about a product using a credit card admission number includes a terminal 100, a POC server 200, a service server 300, a credit card company server 400, and a POS terminal 500. All the constituent elements of the payment system 10 illustrated in FIG. 1 are not essential constituent elements, and the payment system 10 may be implemented by more constituent elements than the constituent elements illustrated in FIG. 1 or less constituent elements therethan.

In a state when agreement to provide personal information is provided in association with the POC server 200, the service server 300, and the credit card company server 400 and a wish list including information on one or more products selected from a promotion product list is stored in the service server 300 by the terminal 100, when a user of the terminal 100 makes a payment for one or more selected products through the POS terminal 500, the POS terminal 500 receives an admission number provided from the credit card company server 400 and transmits the received admission number, store information, details of purchased products, and the like to the service server 300. Further, the credit card company server 400 also transmits the admission number, personal information CI, or the like, to the service server 300. Thereafter, when the admission number related to the terminal 100 which is transmitted from the credit card company server 400 matches the admission number transmitted from the POS terminal 500 and there is product information included in the wish list related to the terminal 100 which is stored in advance in the service server 300, among one or more products included in the details of purchased product transmitted from the POS terminal 500, the service server 300 provides a benefit (for example, including discount, point accumulation, and the like) to the terminal 100 in regard to the specific product information.

The terminal 100 may be applied to various terminals such as a smart phone, a portable terminal, a mobile terminal, a personal digital assistant (PDA), a portable multimedia player (PMP) terminal, a telematics terminal, a navigation terminal, a personal computer, a notebook computer, a slate PC, a tablet PC, an ultrabook, a wearable device (for example, including a smart watch, a smart glass, a head mounted display (HMD), or the like), a Wibro terminal, an internet protocol television (IPTV) terminal, a smart TV, a digital broadcasting terminal, a television, a 3D television, a home theater system, an audio video navigation (AVN) terminal, an audio/video (A/V) system, and a flexible terminal.

Further, the terminal 100 communicates with the POC server 200, the service server 300, the credit card company server 400, the POS terminal 500, and the like.

Further, the terminal 100 performs a member joining procedure for a user of the terminal 100 in association with the POC server 200.

Further, when the member joining procedure is performed, the terminal 100 normally completes the member joining procedure for the POC server 200 only by completing an authentication function through a self-authentication unit (for example, including a mobile phone, a credit card, I-PIN, e-mail, and the like).

Further, the terminal 100 receives a PIN number (personal identification number) which is input by a user through a specific application which is installed in advance in the terminal 100.

Further, the terminal 100 transmits the PIN number or identification information of the terminal 100 to the PIC server 200, the service server 300, the POS terminal 500, and the like to perform a simple payment function.

Further, the terminal 100 accesses the POC server 200. In this case, the terminal 100 may access the POC server 200 through a specific application which is installed in advance in the terminal 100.

Further, the terminal 100 transmits information on an agreement to provide personal information, identification information of the terminal 100, and the like, to the POC server 200. Here, the information on an agreement to provide personal information may be information of giving an agreement to provide personal information (connecting information: CI) related to a user of the terminal 100 for the purpose of marketing to one or more credit card company servers 400 which establish alliance with the service server 300. Further, the identification information of the terminal 100 includes a mobile directory number (MDN), a mobile IP, a mobile MAC, a subscriber identify module (Sim) card unique information, a serial number, and the like.

Further, the terminal 100 receives a promotion product list which is transmitted from the POC server in association with the POC server 200.

Further, the terminal 100 displays the received promotion product list.

Further, the terminal 100 selects at least one product in accordance with selection of the user of the terminal 100.

Further, the terminal 100 transmits a wish list (or an interested product list) including product information relating to at least one selected product and the identification information of the terminal 100 to the POC server 200.

Further, when the payment function is normally performed on one or more products to be paid which are selected by the user of the terminal 100 who visits the store, the user of the terminal 100 receives a receipt which is output as a printed matter from the POS terminal 500. Here, the payment information (or the payment function performed result) includes a product name, a unique product code, a unit price, an amount, a discounted price, whether to apply a coupon, a price, a total price, payment date and time information, and a payment card type.

Further, when a product corresponding to the promotion information which is registered in advance in the service server 300 is purchased by the terminal 100, the terminal 100 receives information (benefit information) on a benefit which is provided from the service server 300.

Further, the terminal 100 displays the received benefit information.

The POC server (point of contact server) 200 communicates with the terminal 100, the service server 300, and the like.

Further, the POC server 200 collects personal information CI from the terminal 100 and provides a promotion product list including promotion information (or benefit) to the terminal 100.

That is, the POC server 200 is connected to the terminal 100 which accesses there through a dedicated application installed in the terminal 100 or a web page.

Further, the POC server 200 receives information on an agreement to provide personal information, identification information of the terminal 100, and the like which are transmitted from the terminal 100. Here, the information on an agreement to provide personal information may be information of giving an agreement to provide personal information (connecting information: CI) related to a user of the terminal 100 for the purpose of marketing to one or more credit card company servers 400 which establish alliance with the service server 300.

Further, the POC server 200 stores the received information on an agreement to provide personal information and identification information of the terminal 100.

As described above, the POC server 200 collects the personal information CI from the terminal 100.

Further, the POC server 200 transmits the received information on an agreement to provide personal information, identification information of the terminal 100, and the like, to the service server 300.

Further, the POC server 200 provides the promotion product list including promotion information which is provided from one or more alliances provided from the service server 300, to the terminal 100.

Further, the POC server 200 receives the wish list (or an interested product list) including product information relating to at least one product selected in accordance with the selection of the user of the terminal 100 from the promotion product list, the identification information of the terminal 100, and the like.

Further, the POC server 200 stores the received wish list (or an interested product list) including product information relating to at least one product and identification information of the terminal 100.

As described above, the POC server 200 provides the promotion information (or a benefit) to the terminal 100 in association with the service server 300.

Further, the POC server 200 transmits the received wish list (or an interested product list) including product information relating to at least one product, identification information of the terminal 100, and the like, to the service server 300.

The service server 300 communicates with the terminal 100, the POC server 200, the credit card company server 400, the POS terminal 500, and the like.

Further, the service server 300 stores (or registers) one or more (or a plurality of) promotion information (or benefit information/promotion information for every product/benefit information for every product) in association with an alliance (not illustrated). Here, the alliance (or an alliance server) includes a manufacturing company which manufactures a specific product and a distributing company which distributes the specific product.

Further, the service server 300 receives the information on an agreement to provide personal information, identification information of the terminal 100, and the like, which are transmitted from the POC server 200.

Further, the service server 300 transmits the received information on an agreement to provide personal information, the identification information of the terminal 100, and the like, to one or more credit card company servers 400 which establish alliance with the service server 300.

Further, the service server 300 receives the wish list (or an interested product list) including product information relating to at least one product transmitted from the POC server 200, the identification information of the terminal 100, and the like.

Further, the service server 300 stores the received wish list (or an interested product list) including product information relating to at least one product and identification information of the terminal 100.

When the payment function is normally performed on one or more product which is selected by the user who visits the store with the terminal 100 in association with the terminal 100, the credit card company server 300, and the POS terminal 500, the service server 300 receives an admission number (for example, including a credit card admission number, and a check card admission number), store information, details of the purchased product, and the like, transmitted from the POS terminal 500. In this case, the details of the purchased product includes one or more product names, a unique product code, a unit price, an amount, a discounted price, whether to apply a coupon, a price, a total price, payment date and time information, and a payment card type.

Further, the service server 300 stores the received admission number (for example, including a credit card admission number and a check card admission number), the store information, and the details of the purchased product.

Further, the service server 300 receives personal information related to the terminal 100, the admission number, and the like, which are transmitted from the credit card company server 400.

Further, the service server 300 determines whether the admission number transmitted from the credit card company server 400 and the previously received admission number which is transmitted from the POS terminal 500 match each other.

As a determination result, when the admission number transmitted from the credit card company server 400 and the previously received admission number which is transmitted from the POS terminal 500 do not match, the service server 300 does not provide the benefit to the terminal 100 but ends the entire processes.

Further, as a determination result, when the admission number transmitted from the credit card company server 400 and the previously received admission number which is transmitted from the POS terminal 500 match, the service server 300 checks whether there is product information (or a product) included in the wish list (or an interested product list) including product information corresponding to at least one product related to the terminal 100 which is stored in advance in the service server 300, among one or more products included in the previously received details of the purchased product which are transmitted from the POS terminal 500.

As a checking result, when there is no product information included in the wish list related to the terminal 100 which is stored in advance in the service server 300, among one or more products included in previously received details of the purchased product which are transmitted from the POS terminal 500, the service server 300 does not provide the benefit for the terminal 100, but ends the entire processes.

Further, as a checking result, when there is product information (for example, one or more first product information) included in the wish list related to the terminal 100 which is stored in advance in the service server 300, among one or more products included in previously received details of the purchased product which are transmitted from the POS terminal 500, the service server 300 provides a benefit (for example, discount, point accumulation, or the like) to the terminal 100 for every corresponding specific product information relating to one or more specific product information included in the wish list related to the terminal 100, among one or more products included in the details of the purchased product.

As described above, when the payment function is performed on a product which is registered in the terminal 100 in advance through the wish list, if there is promotion information (or benefit information) which is registered in advance in the alliance (or alliance server) related to the paid product, the service server 300 provides the benefit according to the promotion related to the product to the terminal 100 which buys the product to maximize an advertising effect of a sponsor (or an alliance) according to the promotion.

The credit card company server 400 communicates with the service server 300 and the POS terminal 500.

Further, the credit card company server 400 performs the payment function on one or more products selected by the user of the terminal 100, in association with the terminal 100 and the POS terminal 500.

Further, the credit card company server 400 is registered in the service server 300 as an alliance.

Further, the credit card company server 400 receives the information on an agreement to provide personal information and the identification information of the terminal 100 which are transmitted from the service server 300.

Further, the credit card company server 400 stores the received information on an agreement to provide personal information and identification information of the terminal 100.

That is, the credit card company server 400 stores information on an agreement to provide personal information for every terminal based on the received information on an agreement to provide personal information and identification information of the terminal 100.

Further, the credit card company server 400 receives information on one or more products to be paid, a payment card type, a payment card number (for example, including a credit card number and a check card number), identification information of the terminal 100, and identification information of the POS terminal 500 transmitted from the POS terminal 500.

Further, the credit card company server 400 performs an authentication procedure for a payment amount corresponding to one or more products to be paid on one or more products to be paid, based on the information on one or more products to be paid, the payment card type, the payment card number, and the like (for example, including the credit card number and the check card number).

Further, after normally performing the authentication procedure, the credit card company server 400 transmits an admission number (for example, including a credit card admission number and a check card admission number) related to the information on one or more products to be paid to the POS terminal 500.

Further, when the authentication procedure fails, the credit card company server 400 transmits information indicating that authentication on one or more products to be paid which are requested by the POS terminal 500 fails, to the POS terminal 500.

After performing the authentication procedure, the credit card company server 400 checks personal information CI (or personal information related to the terminal 100/information on an agreement to provide personal information) corresponding to the credit card number, among information on an agreement to provide personal information for each of a plurality of credit card numbers which is stored in advance in the credit card company server 400.

Further, the credit card company server 400 transmits checked personal information related to the terminal 100 and admission number to the service server 300.

The POS (point of sales) terminal 500 communicates with the terminal 100, the service server 300, and the like.

Further, the POS terminal 500 scans (or recognizes a barcode attached on a product to be paid) one or more products (or payment products) to be paid which are selected by the user of the terminal 100.

Further, the POS terminal 500 displays product information on one or more scanned (or recognized) products to be paid. Here, the product information includes a product name, a unique product code, a unit price, an amount, a price, a total price, and the like.

Further, the POS terminal 500 transmits information on one or more products to be paid, a payment card type, a payment card number (for example, including a credit card number and a check card number), identification information of the terminal 100, and identification information of the POS terminal 500 to the credit card company server 400 related to the payment card number. In this case, in order to perform the simple payment function, the POS terminal 500 may transmit information on one or more products to be paid, a payment card type, a PIN number (or a PIN number related to the terminal 100), identification information of the terminal 100, identification information of the POS terminal 500, and the like to the credit card company server 400 related to the payment card number, in association with the terminal 100 and the POC server 300.

Further, the POS terminal 500 receives the admission number related to the information on one or more products to be paid transmitted from the credit card company server 400, in response to information on one or more products to be paid, the payment card type, and the payment card number which are previously transmitted.

Further, the POS terminal 500 outputs the payment information through a printed matter such as a receipt to provide the payment information to the user of the terminal 100 in accordance with the normally completed approval. Here, the payment information (or the payment function performed result) includes a product name, a unique product code, a unit price, an amount, a discounted price, whether to apply a coupon, a price, a total price, payment date and time information, and a payment card type.

After completing the payment, the POS terminal 500 transmits the admission number (for example, including a credit card admission number and a check card admission number), the store information, and the details of the purchased product to the service server 300. In this case, the details of the purchased product includes one or more product names, a unique product code, a unit price, an amount, a discounted price, whether to apply a coupon, a price, a total price, payment date and time information, and a payment card type.

According to the embodiment of the present invention, it is described that when the payment function is performed using a credit card or a check card which is carried by a user of a terminal 100 which visits an offline store provided with the POS terminal 500, if a product for which a promotion is registered in advance is purchased, an additional benefit is provided. However, the present invention is not limited thereto, when the simple payment function is performed by an electronic wallet application installed in the terminal 100, if a product for which a promotion is registered is purchased, an additional benefit is provided.

Each of the terminal 100, the POC server 200, the service server 300, the credit card company server 400, the POS terminal 500, and the like, includes a communication unit (not illustrated), a storage unit (not illustrated), a display unit (not illustrated), a voice output unit (not illustrated), and a control unit (not illustrated).

The communication unit connects an arbitrary internal component with at least one arbitrary external terminal through a wired/wireless communication network to communicate each other. Here, a wireless internet technique includes wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS). The communication unit transmits and receives data in accordance with at least one wireless Internet technique within a range including Internet techniques which are not listed above. Further, the short range communication technique may include Bluetooth, radio frequency identification (RFID), infrared data association (IrDA), ultra wideband (UWB), ZigBee, near field communication (NFC), ultra sound communication (USC), visible light communication (VLC), Wi-Fi, Wi-Fi direct, or the like. Furthermore, the wired communication technique may include power line communication (PLC), USB communication, Ethernet, serial communication, an optical/coaxial cable, or the like.

Further, the communication unit may mutually transmit information with any terminal through a universal serial bus (USB).

Further, the communication unit transmits and receives a wireless signal to and from a base station, the terminal 100, the POC server 200, the service server 300, the credit card company server 400, the POS terminal 500, and the like on a mobile communication network constructed according to technical standards for mobile communication or communication schemes (for example, global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), or the like).

The storage unit stores various user interfaces UI and graphic user interfaces GUI.

Further, the storage unit stores data and programs which are required to operate the terminal 100, the POC server 200, the service server 300, the credit card company server 400, the POS terminal 500, and the like.

That is, the storage unit may store a plurality of application programs (or applications) driven in the terminal 100, the POC server 200, the service server 300, the credit card company server 400, the POS terminal 500, and the like, and data and commands for the operation. At least some of the application programs may be downloaded from an external service providing device through wireless communication. Further, at least some of the application programs may be installed in the terminal 100, the POC server 200, the service server 300, the credit card company server 400, the POS terminal 500, and the like at the time of release, for a basic function (for example, functions of receiving a call, making a call, receiving a message, and sending a message). In the meantime, the application programs are stored in the storage unit and installed in the terminal 100, the POC server 200, the service server 300, the credit card company server 400, the POS terminal 500, and the like to be driven by the control unit to perform an operation (or function).

Further, the storage unit may include at least one storing medium of a flash memory type, a hard disk type, a multimedia card micro type, a card type memory (for example, an SD or XD memory), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the terminal 100, the POC server 200, the service server 300, the credit card company server 400, the POS terminal 500, and the like, may operate a web storage which performs a storing function of the storage unit on the Internet or operate in association with the web storage.

The display device may display various contents such as various menu screens using a user interface and/or graphic user interface stored in the storage unit, by the control of the control unit. Here, the contents displayed on the display unit may include a menu screen including various texts, image data (including various information data), and data such as icons, a list menu, or a combo box. Further, the display unit may be a touch screen.

Further, the display unit may include at least one of a liquid crystal display (LCD), a thin film transistor liquid crystal display (TFT LCD), an organic light emitting diode (OLED), a flexible display, a three dimensional display (3D display), an e-ink display, and a light emitting diode (LED).

Further, the display unit may be constituted as a stereoscopic display unit which displays a stereoscopic image.

A 3D display scheme such as a stereoscopic type (a glass type), an auto stereoscopic type (a glassless type), or a projection scheme (a holographic type) may be applied to the stereoscopic display unit.

The voice output unit outputs voice information included in a predetermined signal processed signal by the control unit. Here, the voice output unit may include a receiver, a speaker, a buzzer, and the like.

Further, the voice output unit outputs a guidance voice generated by the control unit.

The control unit executes an overall control function of the terminal 100, the POC server 200, the service server 300, the credit card company server 400, the POS terminal 500, and the like.

Further, the control unit executes the overall control function by using the programs and data stored in the storage unit. The control unit may include a RAM, a ROM, a CPU, a GPU, and a bus and the RAM, the ROM, the CPU, and the GPU are connected to each other through the bus. The CPU accesses the storage unit to perform a booting operation using an operating system (O/S) stored in the storage unit and perform various operations using various programs, contents, and data stored in the storage unit.

Further, the terminal 100 may further include an interface unit (not illustrated) serving as an interface with all external apparatuses which are connected to the terminal 100. For example, the interface unit may be constituted by a wired/wireless headset port, an external charger port, a wired/wireless data port, a memory card port, a port connecting devices with identification modules, an audio input/output (I/O) port, a video input/output (I/O) port, an earphone port, and the like. Here, the identification module is a chip which stores various information for authenticating a permission of the terminal 100 and may include a user identity module (UIM), a subscriber identity module (SIM), a universal subscriber identity module (USIM), and the like. Further, the device provided with the identification module may be prepared in a smart card form. Accordingly, the identification module may be connected with the terminal 100 through the port. Such an interface unit receives data or power from an external device to transmit the received data or power to each constituent element in the terminal 100 or transmit the data in the terminal 100 to the external device.

Further, the interface unit may be a passage through which the power from a cradle is supplied to the corresponding terminal 100 when the terminal 100 is connected to an external cradle or a passage through which various command signals input from the cradle by the user is transferred to the corresponding terminal 100. Various command signals input from the cradle or the corresponding power may also operate by a signal for recognizing that the terminal 100 is accurately installed on the cradle.

Further, the terminal 100 may further include an input unit (not illustrated) for receiving a signal according to a button operation of the user or any function selection or receiving a command or a control signal created by an operation such as an operation of touching/scrolling the displayed screen.

The input unit as a means for receiving at least one of a user's command, selection, data, and information may include a plurality of input keys and function keys for receiving figure or text information and setting various functions.

Further, the input unit may use various devices such as a key pad, a dome switch, a touch pad (a pressure resistive type/a contact capacitive type), a touch screen, a jog wheel, a jog switch, a jog shuttle, a mouse, a stylus pen, and a touch pen. Particularly, when the display unit is formed in a touch screen form, some or all of the input functions may be performed by the display unit.

Further, each configuration unit (or each module) of the terminal 100 may be software stored on a memory (or the storage unit) of the terminal 100. The memory may be an internal memory of the terminal 100 and may an external memory or other types of storage devices. Further, the memory may be a non-volatile memory. The software stored on the memory may include a command set to allow the terminal 100 to perform a specific operation while executing.

Further, the POC server 200, the service server 300, and the credit card company server 400 may be implemented in a form such as a web server, a database server, and a proxy server. Further, in the POC server 200, the service server 300, and the credit card company server 400, one or more of various software which allows a network load distribution mechanism or the POC server 200, the service server 300, and the credit card company server 400 to be operated on the Internet or other networks may be installed, and as a result, the POC server 200, the service server 300, and the credit card company server 400 may be implemented by a computerized system. Further, the network may be an http network and may be a private line, Intranet, or any other networks. Furthermore, the POC server 200, the service server 300, and the credit card company server 400 may be connected to the terminal 100 or the POS terminal 500 by a security network so as to suppress the network from being attacked by any hacker or other third parties. Further, the POC server 200, the service server 300, and the credit card company server 400 may include a plurality of database servers, and the database server may be implemented to be separately connected with the POC server 200, the service server 300, and the credit card company server 400 through any type of network connection including a distributed database server architecture.

Further, a processor which is installed in the terminal 100, the POC server 200, the service server 300, and the credit card company server 400 of the present invention may process a program command to execute the method according to the present invention. In an implemented embodiment, the processor may be a single-threaded processor. In another implemented embodiment, the processor may be a multi-threaded processor. Further, the processor may process the command stored on the memory or the storage device.

As described above, a benefit about a product may be provided to a client who uses a credit card, by using an admission number of the credit card.

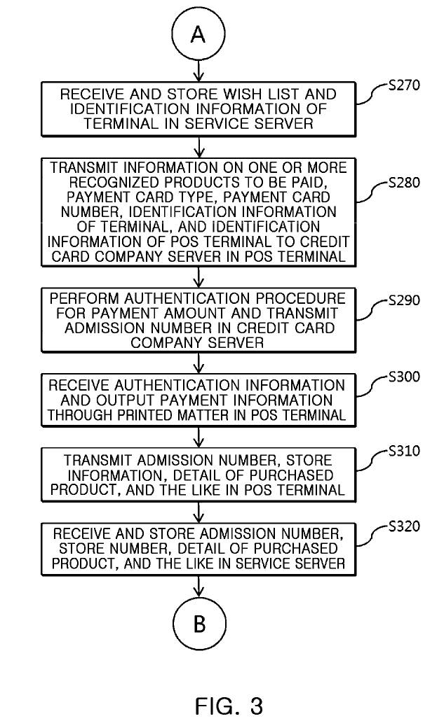

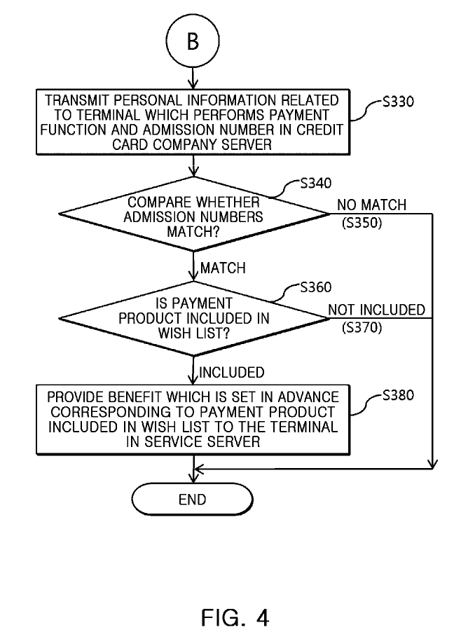

Hereinafter, a control method of a payment system for providing a benefit about a product using an admission number of the credit card according to an embodiment of the present invention will be described in detail with reference to FIGS. 1 to 6.

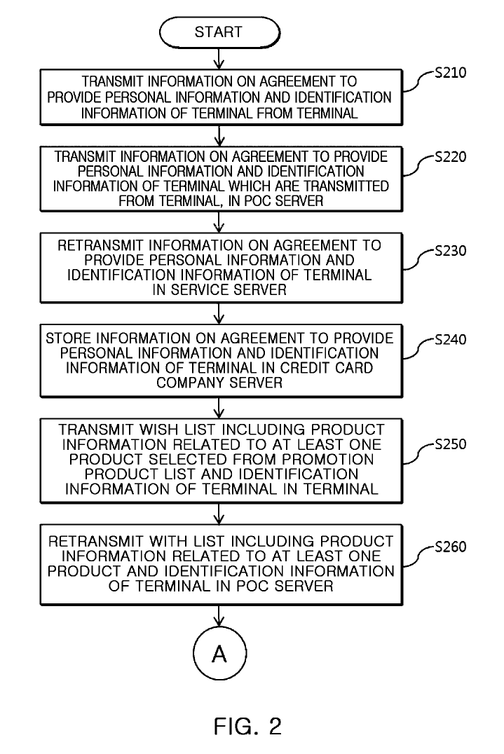

FIGS. 2 to 4 are flowcharts illustrating a control method of a payment system for providing a benefit about a product using a credit card admission number according to an embodiment of the present invention.

First, after accessing the POC server 200, the terminal 100 transmits information on an agreement to provide personal information and identification information of the terminal 100 to the POC server 200. Here, the information on an agreement to provide personal information may be information of giving an agreement to provide personal information (connecting information: CI) related to a user of the terminal 100 for the purpose of marketing to one or more credit card company servers 400 which establish alliance with the service server 300. Further, the identification information of the terminal 100 includes an MDN, a mobile IP, a mobile MAC, a subscriber identify module (Sim) card unique information, and a serial number.

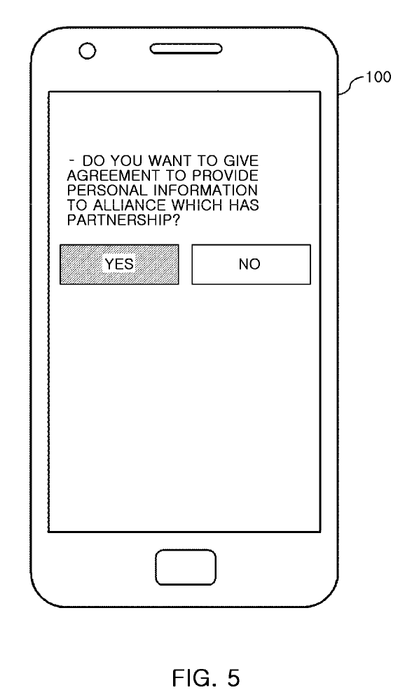

As an example, after accessing the POC server 200 through an electronic wallet application installed in the first terminal, as illustrated in FIG. 5, the first terminal 100 performs a function of giving an agreement to provide personal information CI related to a user of the first terminal for the purpose of marketing to an ABC credit card company servers 400 which establishes alliance with the service server 300 in accordance with the user selection of the first terminal, through a screen which is provided by means of the electronic wallet application. Next, the first terminal transmits information on an agreement to provide personal information and identification information of the first terminal to the POC server 200 (S210).

Next, the POC server 200 receives information on an agreement to provide personal information and identification information of the terminal 100 which are transmitted from the terminal 100.

Further, the POC server 200 transmits the received information on an agreement to provide personal information and identification information of the terminal 100 to the service server 300.

For example, the POC server 200 receives the information on an agreement to provide personal information and identification information of the first terminal which are transmitted by means of the electronic wallet application installed in the first terminal and stores the received information on an agreement to provide personal information and identification information of the first terminal.

Further, the POC server 200 transmits the received information on an agreement to provide personal information related to the first terminal and identification information of the first terminal to the service server 300 (S220).

Next, the service server 300 receives the information on an agreement to provide personal information and identification information of the terminal 100 which are transmitted from the POC server 200.

Further, the service server 300 transmits the received information on an agreement to provide personal information and the identification information of the terminal 100 to one or more credit card company servers 400 which establish alliance with the service server 300.

For example, the service server 300 receives the information on an agreement to provide personal information and identification information of the first terminal which are transmitted from the POC server 200 and transmits the received information on an agreement to provide personal information and the identification information of the first terminal to an ABC credit card company servers 400 which establish alliance with the service server 300 (S230).

Next, the credit card company server 400 receives the information on an agreement to provide personal information and the identification information of the terminal 100 which are transmitted from the service server 300.

Further, the credit card company server 400 stores the received information on an agreement to provide personal information and identification information of the terminal 100.

For example, the ABC credit card company server receives the information on an agreement to provide personal information and identification information of the first terminal which are transmitted from the service server 300 and stores the received information on an agreement to provide personal information and identification information of the first terminal by matching each other (S240).

Next, the terminal 100 selects at least one product from a promotion product list provided from the POC server 200 in accordance with the selection of the user of the terminal 100, in association with the POC server 200.

Further, the terminal 100 transmits a wish list (or an interested product list) including product information relating to at least one selected product and the identification information of the terminal 100 to the POC server 200.

For example, the first terminal selects first to tenth products from a promotion product list provided from the POC server 200, in association with the POC server 200 and transmits a first wish list including first to tenth product information corresponding to the selected first to tenth products, the identification information of the first terminal, and the like, to the POC server 200 (S250).

Next, the POC server 200 receives the wish list (or an interested product list) including product information relating to at least one product and identification information of the terminal 100 which is transmitted from the terminal 100.

Further, the POC server 200 transmits the received wish list (or an interested product list) including product information relating to at least one product and identification information of the terminal 100 to the service server 300.

For example, the POC server 200 receives a first wish list including first to tenth product information corresponding to the first to tenth products which are transmitted from the first terminal and the identification information of the first terminal and transmits the received the first wish list and identification information of the first terminal to the service server 300 (S260).

Next, the service server 300 receives the wish list (or an interested product list) including product information relating to at least one product transmitted from the POC server 200 and the identification information of the terminal 100.

Further, the service server 300 stores the received wish list (or an interested product list) including product information relating to at least one product and identification information of the terminal 100.

For example, the service server 300 receives a first wish list including first to tenth product information corresponding to the first to tenth products which are transmitted from the POC server 200 and the identification information of the first terminal and transmits the received the first wish list and identification information of the first terminal to the service server 300 in association therewith (S270).

Next, the POS terminal 500 scans (or recognizes a barcode attached on a product to be paid) one or more products (or payment products) to be paid which are selected by the user of the terminal 100.

Further, the POS terminal 500 displays product information on one or more scanned (or recognized) products to be paid. Here, the product information includes a product name, a unique product code, a unit price, an amount, a price, a total price, and the like.

Further, the POS terminal 500 transmits information on one or more products to be paid, a payment card type, a payment card number (for example, including a credit card number and a check card number), identification information of the terminal 100, and identification information of the POS terminal 500 to the credit card company server 400 related to the payment card number. In this case, in order to perform the simple payment function, the POS terminal 500 may transmit information on one or more products to be paid, a payment card type, a PIN number (or a PIN number related to the terminal 100), identification information of the terminal 100, and identification information of the POS terminal 500 to the credit card company server 400 related to the payment card number, in association with the terminal 100 and the POC server 300.

For example, the POS terminal 500 recognizes barcodes attached on tenth to twelfth products which are selected by a user of the first user equipment and displays product information on the recognized tenth to twelfth products.

Further, the POS terminal 500 transmits product information on recognized tenth to twelfth products, an AA card (or an AA card type), identification information of the first terminal, and identification information of the POS terminal 500 to the ABC credit card company server (or the payment server, not illustrated) related to the AA card (S280).

Next, the credit card company server 400 receives information on one or more products to be paid, a payment card type, a payment card number (for example, including a credit card number and a check card number), identification information of the terminal 100, and identification information of the POS terminal 500 transmitted from the POS terminal 500.

Further, the credit card company server 400 performs an authentication procedure for a payment amount corresponding to one or more products to be paid on one or more products to be paid, based on the information on one or more products to be paid, the payment card type, the payment card number, and the like (for example, including the credit card number and the check card number).

Further, after normally performing the authentication procedure, the credit card company server 400 transmits an admission number (for example, including a credit card admission number and a check card admission number) related to the information on one or more products to be paid to the POS terminal 500.

For example, the ABC credit card company server performs the authentication procedure on a total payment amount corresponding to the product information on the tenth to twelfth products through the AA card and transmits authentication information (for example, 77001122) in accordance with the authentication procedure to the POS terminal 500 (S290).

Next, the POS terminal 500 receives the admission number related to the information on products to be paid transmitted from the credit card company server 400, in response to information on one or more products to be paid, the payment card type, and the payment card number which are previously transmitted.

Further, The POS terminal 500 outputs the payment information through a printed matter such as a receipt to provide the payment information to the user of the terminal 100 in accordance with the normally completed approval. Here, the payment information (or the payment function performed result) includes a product name, a unique product code, a unit price, an amount, a discounted price, whether to apply a coupon, a price, a total price, payment date and time information, and a payment card type.

For example, the POS terminal 500 receives the admission number (for example, 77001122) transmitted from the ABC credit card company server in response to the product information on the tenth to twelfth products which are previously transmitted, output the payment information as a receipt, and provides the output receipt to the user of the first terminal (S300).

Next, after completing the payment, the POS terminal 500 transmits the admission number (for example, including a credit card admission number and a check card admission number), the store information, and the details of the purchased product to the service server 300. In this case, the details of the purchased product includes one or more product names, a unique product code, a unit price, an amount, a discounted price, whether to apply a coupon, a price, a total price, payment date and time information, and a payment card type.

For example, the POS terminal 500 transmits the admission number (for example, 77001122) of the AA credit card, the store information, and the details of the purchased product (for example, including the tenth to twelfth product information corresponding to the tenth to twelfth products) to the service server 300 (S310).

Next, the service server 300 receives the admission number (for example, including a credit card admission number and a check card admission number), the store information, and the details of the purchased product which are transmitted from the POS terminal 500.

Further, the service server 300 stores the received admission number (for example, including a credit card admission number and a check card admission number), store information, and details of the purchased product.

For example, the service server 300 receives and stores the admission number (for example, 77001122) of the AA credit card, store information, and details of the purchased product (for example, including the tenth to twelfth product information corresponding to the tenth to twelfth products) which are transmitted from the POS terminal 500 (S320).

After performing the authentication procedure, the credit card company server 400 checks personal information CI (or personal information related to the terminal 100/information on agreement to provide personal information) corresponding to the credit card number, among information on agreement to provide personal information for each of a plurality of credit card numbers which is stored in advance in the credit card company server 400.

Further, the credit card company server 400 transmits checked personal information related to the terminal 100 and admission number to the service server 300.

For example, after performing the authentication procedure through the AA card, the ABC credit card company server checks personal information CI (or information on agreement to provide personal information) related to the first terminal corresponding to the AA credit card, among information on agreement to provide personal information for each of a plurality of credit card numbers which is stored in advance in the AAA credit card company server and transmits the checked personal information CI and the admission number (for example, 77001122) corresponding to the AA card to the service server 300 (S330).

Next, the service server 300 receives personal information related to the terminal 100 and the admission number which are transmitted from the credit card company server 400.

Further, the service server 300 determines whether the admission number transmitted from the credit card company server 400 and the previously received admission number which is transmitted from the POS terminal 500 match.

For example, the service server 300 determines whether the authentication information transmitted from the ABC credit card company server and the authentication information transmitted from the POS terminal 500 match (S340).

As a determination result, when the admission number transmitted from the credit card company server 400 and the previously received admission number which is transmitted from the POS terminal 500 do not match, the service server 300 does not provide the benefit to the terminal 100 but ends the entire processes.

For example, when the authentication information transmitted from the ABC credit card company server and the authentication information transmitted from the POS terminal 500 do not match, the service server 300 ends the entire processes (S350).

Further, as a determination result, when the admission number transmitted from the credit card company server 400 and the previously received admission number which is transmitted from the POS terminal 500 match, the service server 300 checks whether there is product information (or a product) included in the wish list (or an interested product list) including product information corresponding to at least one product related to the terminal 100 which is stored in advance in the service server 300, among one or more products included in the previously received details of the purchased product which are transmitted from the POS terminal 500.

For example, when the authentication information transmitted from the ABC credit card company server and the authentication information transmitted from POS terminal 500 match, the service server 300 checks whether there is product information included in the first wish list (for example, including first to tenth product information) related to the terminal 100 which is stored in advance in the service server 300, among tenth to twelfth products included in the details (for example, including the tenth to twelfth product information corresponding to the tenth to twelfth products) of the purchased product which is transmitted from the POS terminal 500 (S360).

As a checking result, when there is no product information included in the wish list related to the terminal 100 which is stored in advance in the service server 300, among one or more products included in previously received details of the purchased product which are transmitted from the POS terminal 500, the service server 300 does not provide the benefit for the terminal 100, but ends the entire processes.

For example, when there is no product information included in a second wish list including twenty first to twenty third product information related to the terminal 100 which is stored in advance in the service server 300, among tenth to twelfth products included in the details of the purchased product which are transmitted from the POS terminal 500, the service server 300 ends the entire processes (S370).

Further, as a checking result, when there is product information (for example, one or more first product information) included in the wish list related to the terminal 100 which is stored in advance in the service server 300, among one or more products included in details of the purchased product which is previously received from the POS terminal 500, the service server 300 provides a benefit (for example, discount or point accumulation) to the terminal 100 for every corresponding specific product information relating to one or more specific product information included in the wish list related to the terminal 100, among one or more products included in the details of the purchased product.

Further, the terminal 100 receives information (or benefit information) on a benefit provided from the service server 300 and displays the received benefit information.

For example, when there is tenth product information included in the first wish list related to the first terminal which is stored in advance in the service server 300, among tenth to twelfth products included in the details of purchased product transmitted from the POS terminal 500, the service server 300 provides a benefit of 10% accumulation for a payment amount of the tenth product information which is a benefit according to a promotion which is set in advance according to the tenth product information, to the terminal 100.

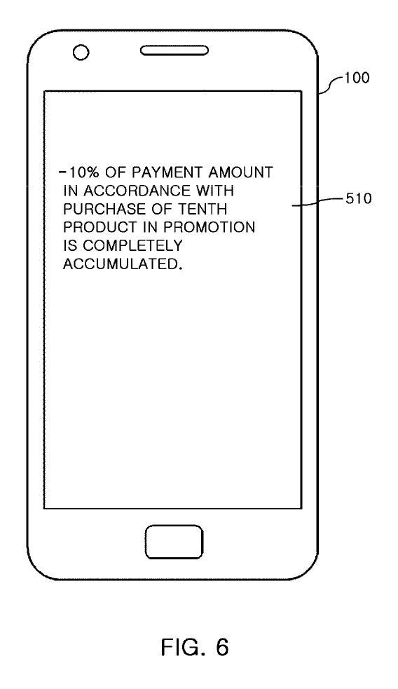

Further, the terminal 100 receives information on the benefit of 10% accumulation for the tenth product which is provided from the service server 300 and displays the received information 510 on the benefit of 10% accumulation for the tenth product, as illustrated in FIG. 6 (S380).

The terminal, the server, the POS terminal and the payment system including the same according to the embodiment of the present invention may be prepared with a computer program, and codes and code segments configuring the computer program may easily deduced by a computer programmer in the art. Further, the corresponding computer program is stored in a non-transitory computer readable storage medium, and read and executed by the terminal, the server, and the POS terminal according to the embodiment of the present invention to implement the terminal, the server, the POS terminal, and the payment system including the same.

The non-transitory computer readable storage medium includes a magnetic storage medium, an optical storage medium, and a carrier wave medium. The computer program implementing the terminal, the server, the POS terminal, and the payment system including the same according to the embodiment of the present invention may be stored and installed in embedded memories of the terminal, the server, the POS terminal, and the like. Alternatively, external memories such as a smart card storing and installing the computer program implementing the terminal, the server, the POS terminal, and the payment system including the same according to the embodiment of the present invention may be installed on the terminal, the server, the POS terminal, the payment system, and the like including the same through an interface.

As described above, according to the embodiment of the present invention, a benefit about a product is provided to a client who uses a credit card, by using the admission number of the credit card so that a manufacturer may perform a promotion about the product in accordance with recognition of the product purchased by the client and the client may receive a benefit about the product without performing additional action at the time of making a payment, and the credit card company may conveniently provide a benefit to the client to increase the usage rate of the card.

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description. Therefore, the spirit of the present invention should not be limited to the above-described embodiments, and the following claims as well as all modified equally or equivalently to the claims are intended to fall within the scope and spirit of the invention.

The present invention has advantages of providing a benefit about a product to a client who uses a credit card, by using the admission number of the credit card so that a manufacturer may perform a promotion about the product in accordance with recognition of the product purchased by the client and the client may receive a benefit about the product without performing additional action at the time of making a payment, and the credit card company may conveniently provide a benefit to the client to increase the usage rate of the card and can be widely used in a promotion field, a terminal field, a server field, a marketing field, and the like.

What is claimed is:

1. A control method of a service server comprising:
receiving a wish list including product information relating to at least one product and identification information of a terminal which are transmitted from a point of contact (POC) server, by means of a communication unit;
receiving an admission number, store information, and details of one or more purchased products which are transmitted from the POS terminal after a payment is made on the one or more purchased products purchased by a user of a terminal, by means of the communication unit;
receiving personal information related to the terminal and admission number which are transmitted from a credit card company server, by means of the communication unit;
determining whether the admission number which is transmitted from the credit card company server and the received admission number which is transmitted from the POS terminal match, by means of a control unit;
checking whether there is product information included in the received details of the one or more purchased products which matches with the product information included in the wish list, by means of the control unit, when the admission number which is transmitted from the credit card company server and the received admission number which is transmitted from the POS terminal match as the determination result; and
providing a benefit which is registered in advance with respect to one or more first product information to the terminal, by means of the control unit, when there is the product information included in the received details of the one or more purchased products which matches with the one or more first product information included in the wish list as the checking result.

2. The control method of claim 1, wherein the details of the purchased product includes at least one of one or more product names, a unique product code, a unit price, an amount, a discounted price, whether to apply a coupon, a price, payment date, and time information, a total price, and a payment card type.

3. The control method of claim 1, wherein the providing of a benefit which is registered in advance with respect to one or more first product information to the terminal includes:
storing benefit information on each of a plurality of products which is transmitted from each of a plurality of alliances in a storage unit, by means of the control unit;
checking benefit information corresponding to first product information among benefit information for each of the plurality of products which is stored in the storage unit, by means of the control unit, when the admission number which is transmitted from the credit card company server and the received admission number which is transmitted from the POS terminal match and there is the product information included in the received details of the one or more purchased products which matches with the one or more first product information included in the wish list; and
providing the checked benefit information to the terminal, by means of the control unit.

4. The control method of claim 1, wherein the benefit is at least one of point accumulation and discount.

5. A control method of a payment system for providing a benefit about a product using an admission number of a credit card, the control method comprising:
transmitting information on agreement to provide personal information and identification information of a terminal to a credit card company server via a POC server and a service server, by means of the terminal;
storing the information on agreement to provide personal information for every terminal by matching the information on agreement to provide personal information and the identification information of the terminal, by means of the credit card company server;
transmitting a promotion product list to the terminal, by means of the POC server;
transmitting the wish list including product information relating to at least one product selected by a user of the terminal from the promotion product list and the identification information of the terminal to the service server via the POC server, by means of the terminal;
scanning one or more products to be paid selected by the user of the terminal, by means of the POS terminal;
transmitting information on the scanned one or more products to be paid, a payment card type, a payment card number, identification information of the terminal, and identification information of the POS terminal to the credit card company server, by means of the POS terminal;
performing an authentication procedure based on the information on one or more products to be paid, the payment card type, and the payment card number, by means of the credit card company server; and
transmitting an admission number to the POS terminal when the authentication procedure is normally performed, by means of the credit card company server.

6. The control method of claim 5, further comprising:
receiving an admission number transmitted from the credit card company server in response to the transmitted information on one or more products to be paid and transmitting the received admission number, store information, and details of purchased product to the service server, by means of the POS terminal;
storing the admission number, the store information, and the details of the purchased product which are transmitted from the POS terminal, by means of the service server;
transmitting personal information corresponding to the credit card number and the admission number among information on agreement to provide personal information for each of a plurality of credit card numbers which is stored in advance in the credit card company server after performing the authentication procedure to the service server, by means of the credit card company server;
determining whether the admission number which is transmitted from the credit card company server and the received admission number which is transmitted from the POS terminal match, by means of the service server;
checking whether there is product information included in the received details of the one or more purchased products which matches with the product information included in the wish list, by means of the service server, when the admission number which is transmitted from the credit card company server and the received admission number which is transmitted from the POS terminal match; and
providing a benefit which is registered in advance with respect to one or more first product information to the terminal, by means of the service server, when there is the product information included in the received details of the one or more purchased products which matches with the one or more first product information included in the wish list.

7. A non-transitory computer readable storage medium having a computer program recorded thereon configured to perform the method according to claim 1.

8. A non-transitory computer readable storage medium having a computer program recorded thereon configured to perform the method according to claim 2.

9. A non-transitory computer readable storage medium having a computer program recorded thereon configured to perform the method according to claim 3.

10. A non-transitory computer readable storage medium having a computer program recorded thereon configured to perform the method according to claim 4.

11. A non-transitory computer readable storage medium having a computer program recorded thereon configured to perform the method according to claim 5.

12. A non-transitory computer readable storage medium having a computer program recorded thereon configured to perform the method according to claim 6.

13. A service server comprising:
a communication unit which receives a wish list including product information relating to at least one product transmitted from a POC server and identification information of a terminal, an admission number, store information, and details of one or more purchased products which are transmitted from a POS terminal after a payment is made on the one or more purchased products purchased by a user of the terminal, and personal information related to the terminal and the admission number transmitted from a credit card company server;
a storage unit which stores the received wish list including product information relating to at least one product and admission number of the terminal; and
a control unit which determines whether the admission number transmitted from the credit card company server and the received admission number transmitted from the POS terminal match, checks whether there is product information included in the received details of the one or more purchased products which matches with the one or more first product information included in the wish list when the admission number transmitted from the credit card company server and the received admission number transmitted from the POS terminal match, and provides a benefit which is registered in advance with respect to one or more first product information to the terminal when when there is the product information included in the received details of the one or more purchased products which matches with the one or more first product information included in the wish list.
